(19) United States
(12) Patent Application Publication
(10) Pub. No.: US 2012/0077165 A1
(43) Pub. Date: Mar. 29, 2012

(54) INTERACTIVE LEARNING METHOD WITH DRAWING

(76) Inventor: Joanne Liang, San Jose, CA (US)

(21) Appl. No.: 12/958,015

(22) Filed: Dec. 1, 2010

(30) Foreign Application Priority Data
Sep. 23, 2010 (TW) 99132214

(51) Int. Cl. G09B 19/00

(52) U.S. Cl. 434/261

(57) ABSTRACT

An interactive learning method with drawing is implemented by the execution of a program incorporated with a screen. A sequence of dots is provided on the screen. Children connect adjacent dots starting from the starting dot in sequence. A connecting line appears between a pair of adjacent dots when they are connected successively. Finally, those connecting lines constitute an object when all the pairs of adjacent dots have been connected and a series of images or an animation related to the object is displayed to strengthen children's learning impression and recognition ability. After that, a few buttons are provided on screen. When the button is touched or clicked by the children, its corresponding object is explained by text or/and voice. By doing so, it may enhance their ability of reading and listening. Hence, this interactive learning method can increase children's interest in learning. Consequently, they can learn by themselves.

### BACKGROUND OF THE INVENTION

1. Field of the Invention

The present invention is generally related to a method of learning, and more particularly to an interesting and interactive method of learning with drawing.

2. Description of the Related Art

Children have a great ability of learning. However, their focus is often interrupted or distracted by their surroundings. Therefore, how to efficiently draw in children's attention and motivate them to learn has been the main concern of parents, teachers and developers of learning materials.

A lot of learning materials in the market are created for children at different ages. For example, flash cards are designed to use pictures as media to teach children to recognize the objects or characters in the pictures, and help them to understand their meaning, which is usually given by the accompanying parents or teachers. Such kind of learning materials can only be used while parents or teachers are around. This is because they are required to give instruction and assistance even though pictures and colors can often catch the attention of children. In other words, parents or teachers are the real source of knowledge. Without their presence, such learning materials lose the function of delivering knowledge.

### SUMMARY OF THE INVENTION

The primary objective of the present invention is to provide an interactive learning method with drawing. A computer (PDA, iPAD or mobile phones, or other devices on which programs can execute) is used as the platform and a screen as the interface. By using the powerful functions of processing pictures, animation and sound provided by computers, the present invention may increase children's interest in learning in an interactive way via the interface. Consequently, they can learn by themselves.

To meet the primary objective, the interactive learning method with drawing proposed in this invention is implemented by the execution of a program incorporated with a monitor. The steps in the method include: (1) Clicking a connection item on the screen to activate a sequence of dots to appear on the screen, starting from the starting dot C1, the second dot C2, and so forth until the m^{th} dot Cm. (2) From the starting dot, children connect each dot to its next dot in sequence. (3) The program will examine if the next dot is connected successfully. If it is, the program will proceed to connect the next dot. If not, the program will restart from the last successfully connected dot and the children have to connect it to its next dot again.

In the interactive learning method with drawing proposed in this invention, a series of images or an animation related to the connection item will be displayed after completing all the connections between adjacent dots in sequence to strengthen the learning impression.

### BRIEF DESCRIPTION OF THE DRAWINGS

FIG. 1 is a sketch diagram of the system for the interactive learning method with drawing of a first preferred embodiment of the present invention;

FIG. 2 is a flow chart of the operation of the first preferred embodiment of the present invention;

FIG. 3 to FIG. 10 are sketch diagrams of the operation of the first preferred embodiment of the present invention;

FIG. 11 and FIG. 12 are sketch diagrams of the drawing interface and the dot-connecting-drawing in a second preferred embodiment of the present invention;

FIG. 13 to FIG. 15 are sketch diagrams of the drawing interface and the dot-connecting-drawing in a third preferred embodiment of the present invention;

FIG. 16 is a ketch diagram of the question window and the scoring window in a fourth preferred embodiment of the present invention;

FIG. 17 is a sketch diagram of the drawing interface and the dot-connecting-drawing in a fifth preferred embodiment of the present invention; and

FIG. 18 is a sketch diagram of the drawing interface and the dot-connecting-drawing in a sixth preferred embodiment of the present invention.

### DETAILED DESCRIPTION OF THE INVENTION

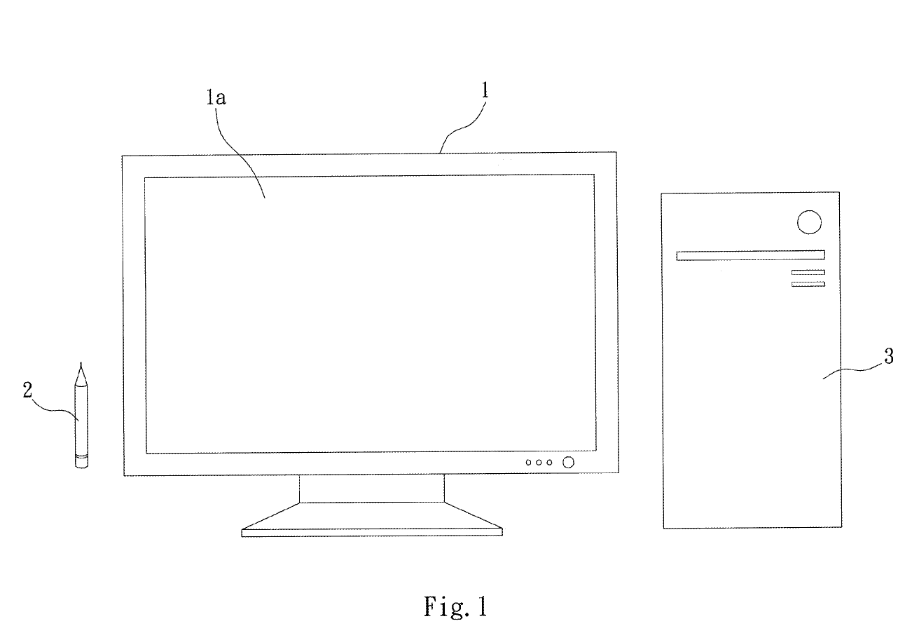

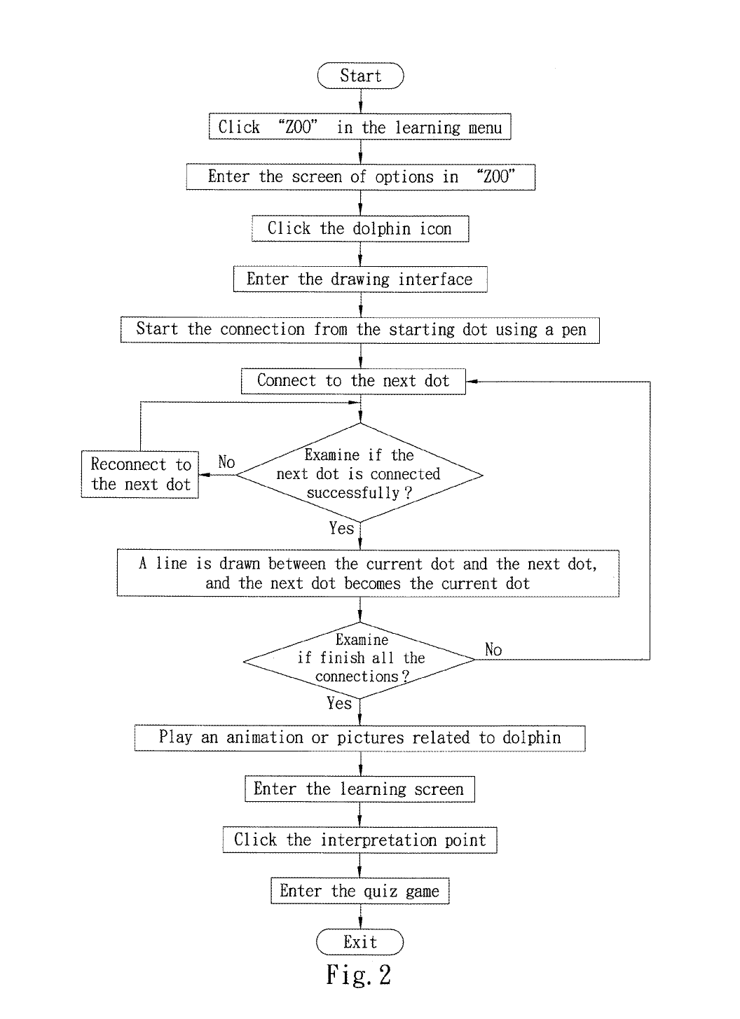

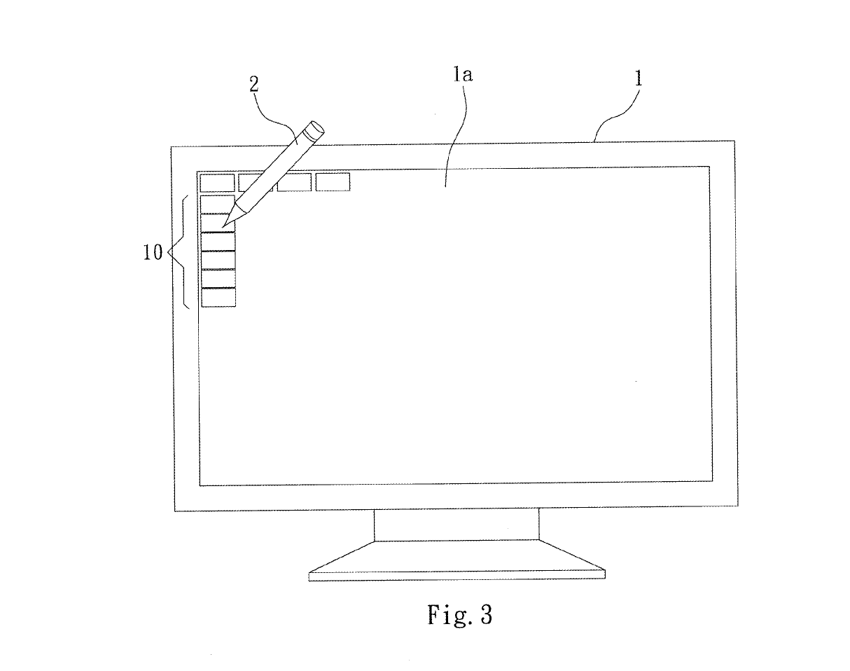

The present invention provides an interactive method for children to learn by execution of a program incorporated with a monitor. As shown in FIG. 1, the first preferred embodiment of the present invention provides a monitor 1 connected to a machine 3 on which programs can execute. The children interact with a touch screen 1a of the monitor 1 with a pen 2. Please refer to FIG. 2 for the flow chart of the operation when executing the program of the present invention. FIG. 3 to FIG. 10 demonstrates how to interact with the touch screen 1a.

In FIG. 3, the screen 1a contains a learning menu 10. The learning menu 10 has several items for the user to choose from, such as “ZOO”, “ENGLISH VILLAGE”, “GYM”, and other icons. A child may click the items on the screen 1a with the pen 2. To make the following description easier to understand, we assume that one kid clicks “ZOO” in the following paragraphs.

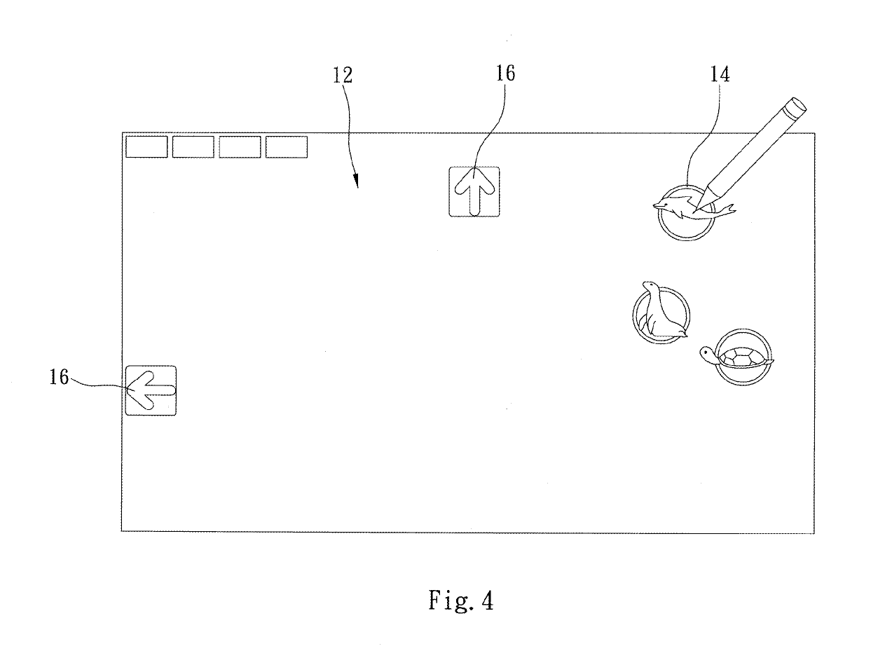

In FIG. 4, a screen of options 12 appears after one clicks on “ZOO”. The screen of options 12 has several connection items 14 represented by animal icons, such as dolphin, turtle, cock, and so forth. In fact, the connection items 14 can be represented by texts or something in other forms. The screen 1a also shows several arrows 16 to expand the screen for more options of animals. The connection items 14 can be chosen by clicking their icons with the pen 2. It is noted that if the user clicks “ENGLISH VILLAGE”, the connection items 14 are represented by texts rather than icons.

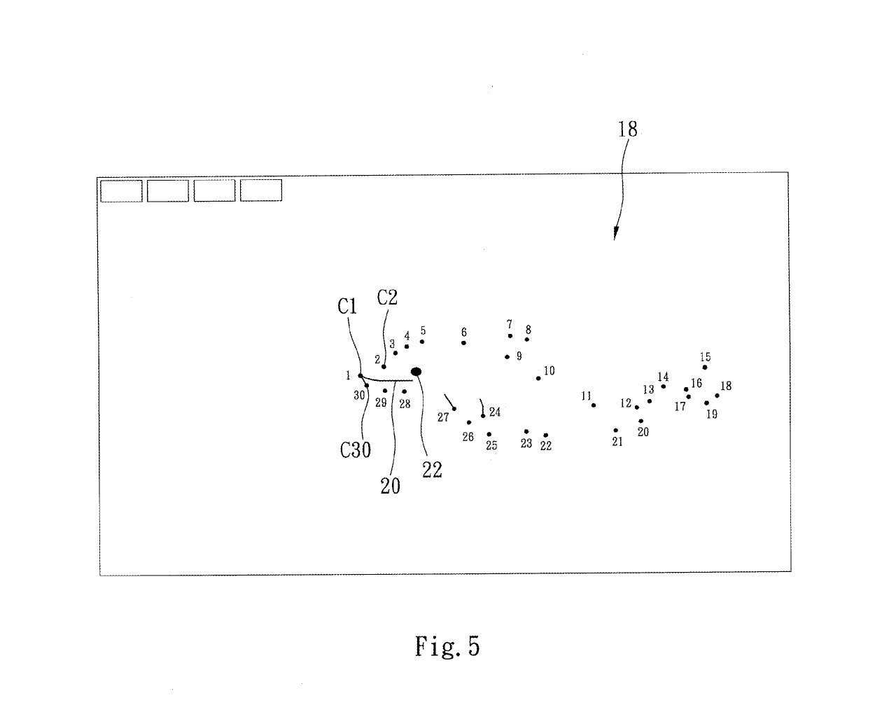

FIG. 5 shows a drawing interface 18 after clicking or hitting the “dolphin” in FIG. 4. The drawing interface 18 contains a sequence of dots, starting from a starting dot C1, a second dot C2 . . . , till a 30^{th} dot C30. These dots C1˜C30 orderly form the shape of a dolphin. It is noted that the number of the dots varies according to the image to draw. In order to guide the children to draw correctly, the numbers from 1 to 30 are further provided in the drawing interface 18 of the present embodiment. Each number has its own corresponding dot. For example, 1 corresponds to C1, 2 corresponds to C2, . . . , and 30 corresponds to C30. These numbers are placed beside their corresponding dots. However, the numbers can also be removed to increase the difficulty. The drawing interface 18 can also be added with auxiliary lines 20 and auxiliary dots 22 to get a better shape of a dolphin.

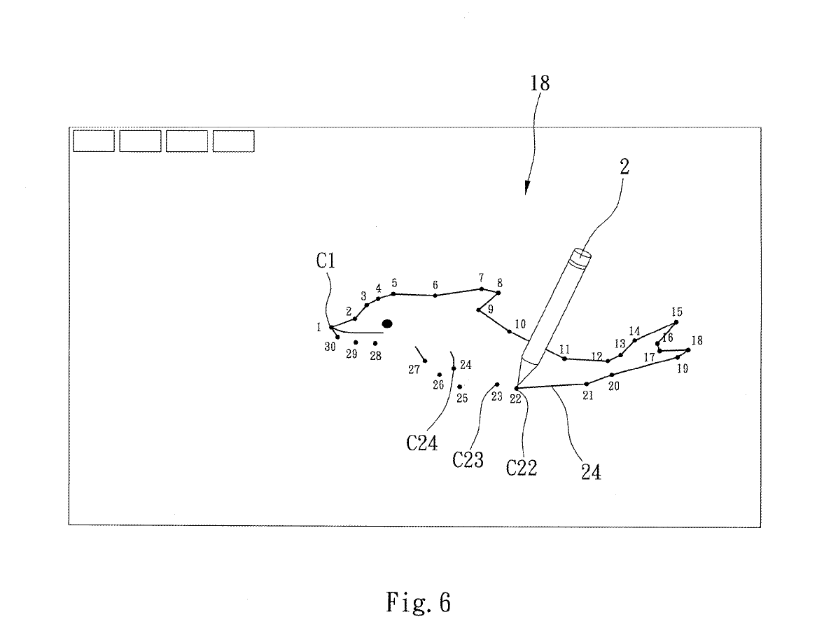

In FIG. 6, a child is connecting the dots on the drawing interface 18 with the pen 2. Following the order of the numbers, he/she starts from C1 to connect each dot to its next dot in sequence. In fact, connecting a dot to its next dot is drawing from the dot to its next dot with the pen 2 on the touch screen. A connecting line 24 will appear between adjacent dots if the connection between them succeeds. The result of connecting from C1 to C22 in sequence is also shown in FIG. 6. It is noted that when a user tries to connect dots without following the order, it is detected as wrong connection and no connecting line is produced. For example, if the user is now trying to connect from C22 to C24, no connecting line will appear between C22 and C24 on the drawing interface 18. The user has to restart from C22 until he/she successfully connects from C22 to C23, and then a connecting line between C22 and C23 appears on the drawing interface 18. That is, restarting the connection from the last successfully connected dot C22 rather than the staring dot C1 in order not to decrease the enjoyment of the drawing. Besides, when the user tries to connect from C22 to C23 but he/she takes the pen off the screen before the C23 is reached, no connecting line will appear between C22 and C23. Similarly, a reconnection has to start from C22.

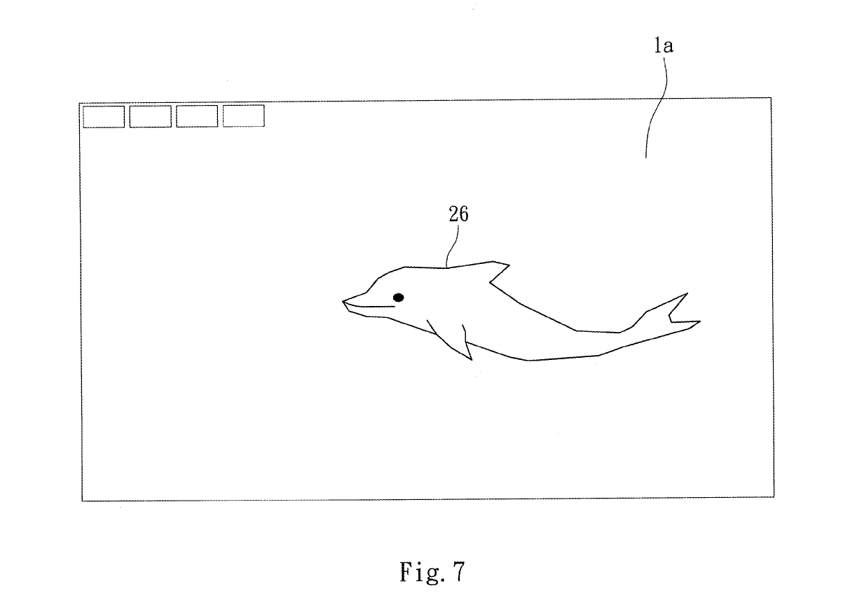

After the user connects all of the dots from C1 to C30 in sequence, the connecting lines form a shape of a dolphin 26 as shown in FIG. 7. We call this kind of drawing the “dot-connecting-drawing”.

After the dolphin is shown, an animation or a video with text or voice is played on screen 1a to tell the user more information about the theme—the dolphin in this case. In fact, the dolphin created by the dot-connecting-drawing moves in the animation or video such that the user can know the behavior of the dolphin. It is noted that the object moves in the animation after the dot-connecting-drawing may not be the one drawn by the user. For example, it may show the animation of “running water” after the child draws a “faucet”, or it may just shows some pictures to tell more information when the user finishes the dot-connecting-drawing.

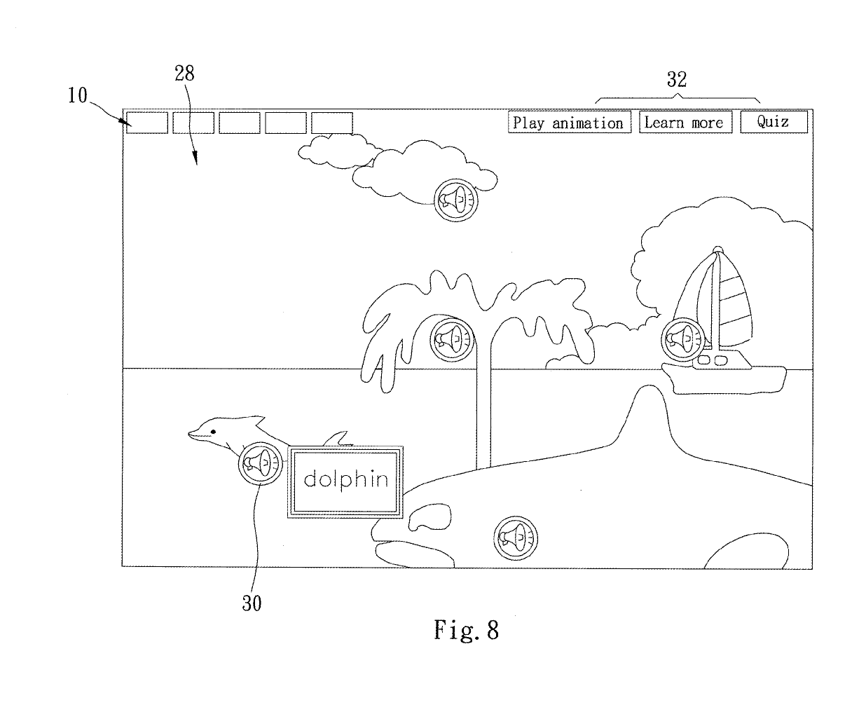

After the animation, a learning screen 28 is shown in FIG. 8. The learning screen 28 contains several interpretation points 30. Each of them corresponds to an object on the screen. When the interpretation point 30 is touched or clicked by the children, its corresponding object is explained by text or/and voice. By doing so, it may enhance their ability of reading and listening.

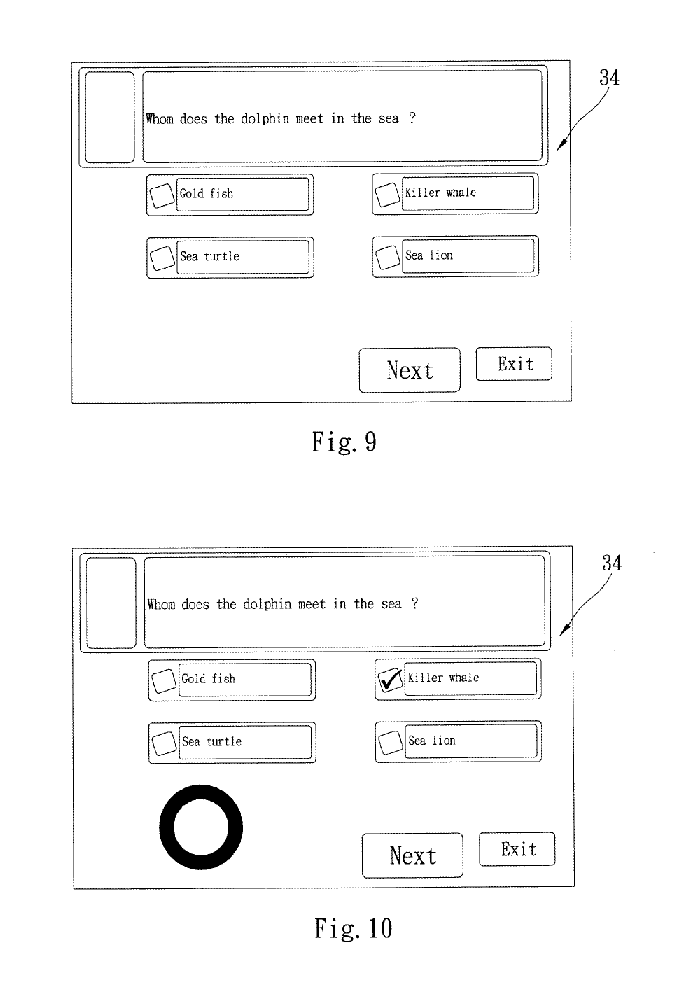

The learning screen 28 also includes an advance menu 32, including “play animation”, “learn more”, “quiz”, and other options. The animation is played again when the child hits “play animation”. More knowledge about the animation is displayed when the child hits “learn more”. When the child hits “quiz”, a quiz game 34 as shown in FIG. 9 begins. The quiz game 34 contains several multiple-choice questions about the animation, such as “Whom does the dolphin meet in the sea?”. Some possible answers are also provided, such as “gold fish”, “killer whale”, “sea turtle”, and “sea lion”. The child tries to choose the correct answer from them. The screen will show “o” when the child chooses the correct answer, as shown in FIG. 10, or “x” for the wrong answer. The child may hit “next” for the next question or “exit” to go back to the learning screen 28 in FIG. 8. The quiz game 34 may train children's attention and memory.

The learning method of the first preferred embodiment of the present invention may attract children to learn by doing the dot-connecting-drawing. The animation or video after the dot-connecting-drawing may enhance children's ability of understanding and cognition. The design of the interpretation points may train children to read and listen, and the quiz game may enhance the children's attention and memory. The present invention provides an interactive learning method to attract children to learn.

In order to make the learning process more interesting, the dot-connecting-drawing may vary as follows.

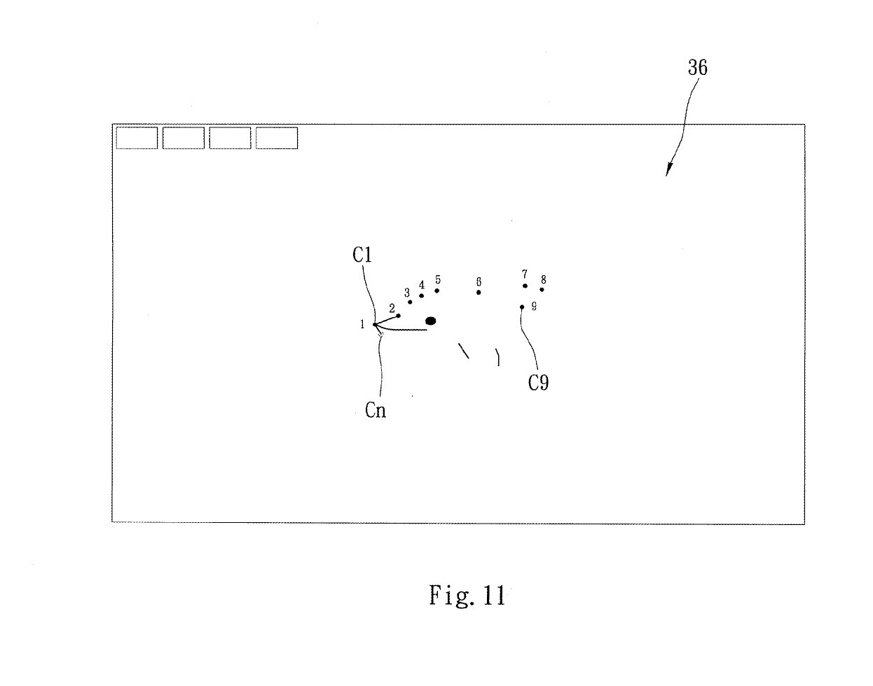

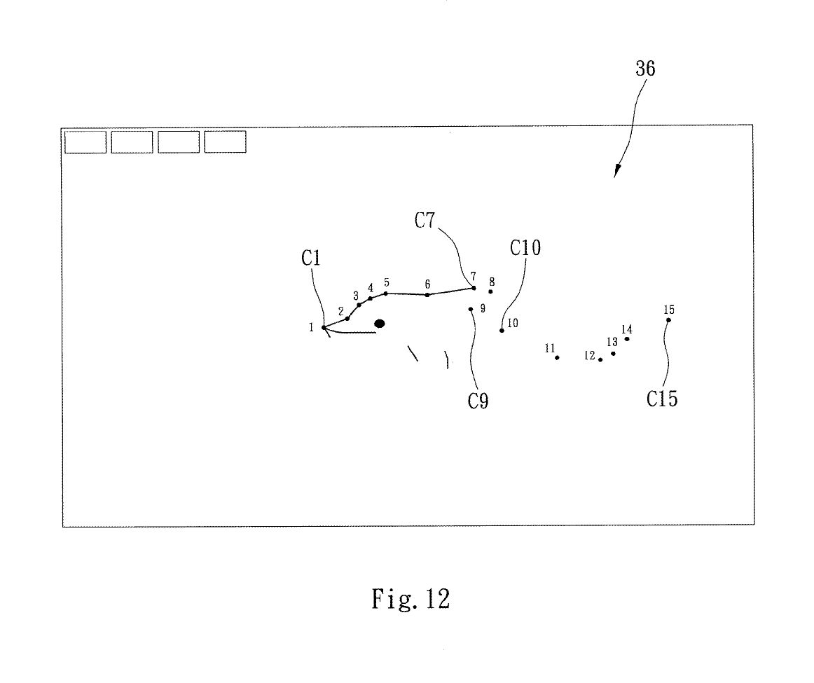

FIG. 11 shows the second preferred embodiment of the present invention, in which a drawing interface 36 is used for the same dolphin used earlier. This preferred embodiment differs from the first preferred embodiment in the number of dots provided in the beginning. Only partial dots starting from the starting dot C1 appear on the drawing interface 36 in the beginning. For example, only nine dots, C1 to C9, appear on the drawing interface 36. When the child correctly completes the connection between C1 and C2, C10 appears on the drawing interface 36. The child continues to complete the connection between C2 and C3, C11 appears on the drawing interface 36. This process continues until the last dot Cn (represented as a hollow dot in FIG. 11) appears and it is successfully connected. In summary, a next new dot appears when a connection completes. FIG. 12 shows that the child has completed the connections from C1 to C7, so six dots, C10 to C15, also appear on the drawing interface 36. In other words, there are always eight dots waiting for connection on the drawing interface 36 before the last dot Cn appears. When the child finishes connecting all the dots, C1 to Cn, the shape of dolphin formed with the connecting lines appears on the screen. Because only partial dots appear on the screen most of the time, the child will not know what he/she going to draw and the appearance of dolphin is becoming clearer as more dots are connected. This may make the process more interesting.

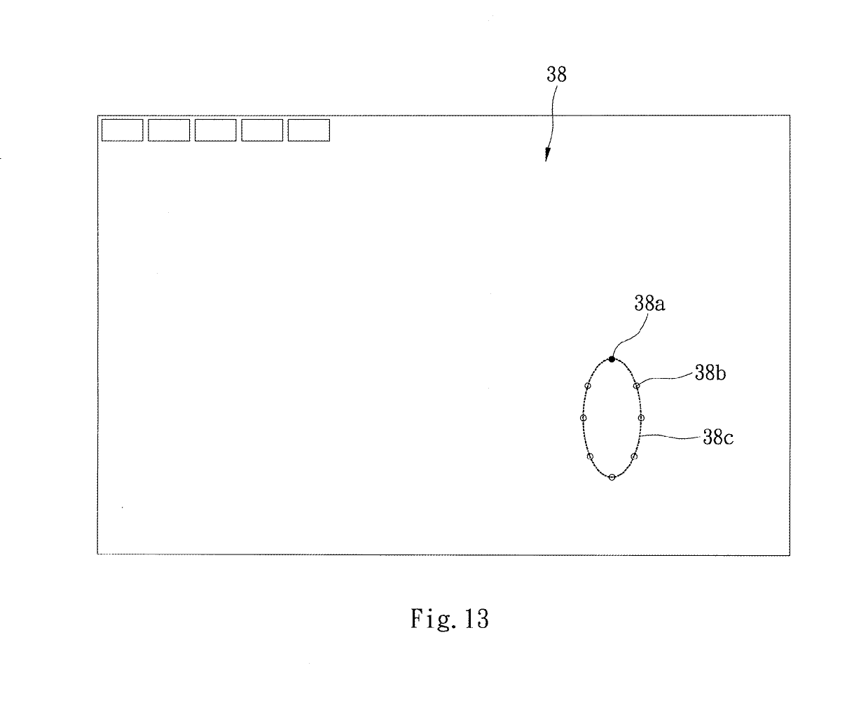

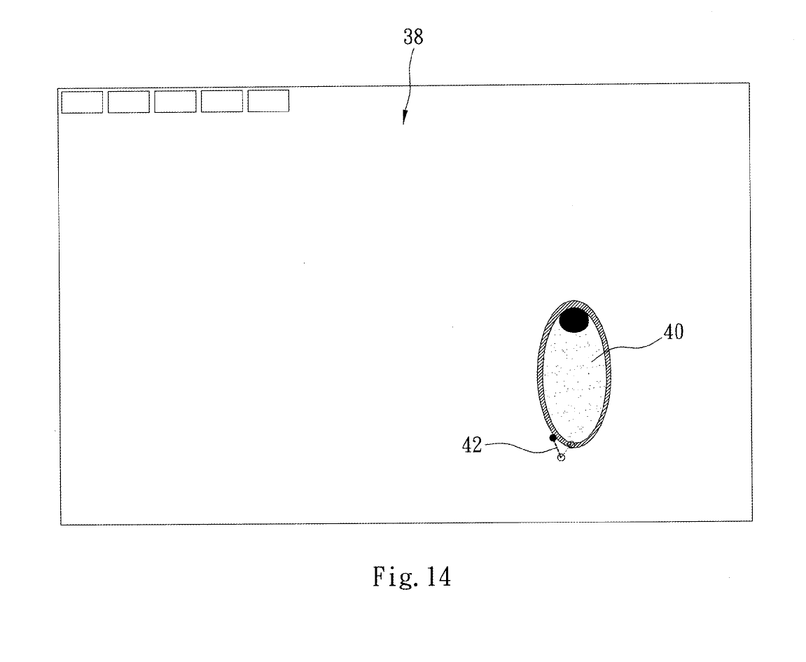

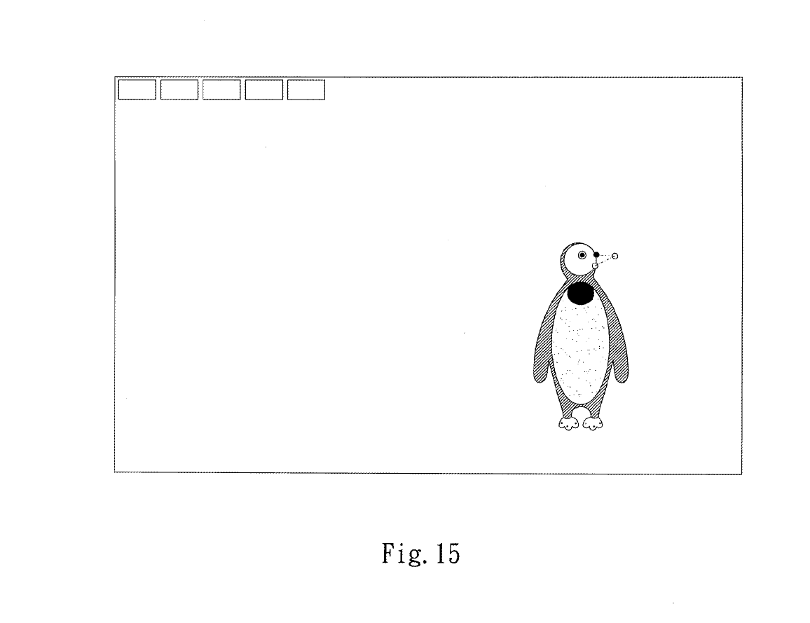

FIG. 13 shows the third preferred embodiment of the present invention. A penguin will be drawn here. The different part of this preferred embodiment is that a drawing interface 38 provides more than one sequence of dots. In FIG. 13, there is a sequence of dots including a solid dot 38a and a number of hollow dots 38b. A dot line 38c connects the dots 38a and 38b. The solid dot 38a is the starting dot and the end dot of the sequence at the same time. However, the solid dot 38a and the hollow dots 38b can be represented by different colors, and then they can be distinguished by their colors. After the child has done the dot-connecting-drawing on this sequence of dots, the connecting lines constitute a closed area and a portion of a penguin picture 40 appears in this area as shown in FIG. 14. In the meantime, another sequence of dots 42 appears and the user will do the dot-connecting-drawing on them next. This process continues until the last sequence of dots is processed by the dot-connecting-drawing, and then a penguin picture appears on the screen as shown in FIG. 15. In the present embodiment, the connecting lines in each sequence of dots constitute a closed area. However, it is not necessarily a closed area. It is possible that it is a line with some turning points. Hence, it is not necessary that a portion of a penguin picture appears for each sequence of dots. Sometimes, the connecting lines of multiple sequences are required to constitute a closed area. Similarly, a portion of a penguin picture appears in the closed area. However, it is not necessary that the closed area is filled with a portion of a penguin picture. Instead, the user can fill color in the closed area.

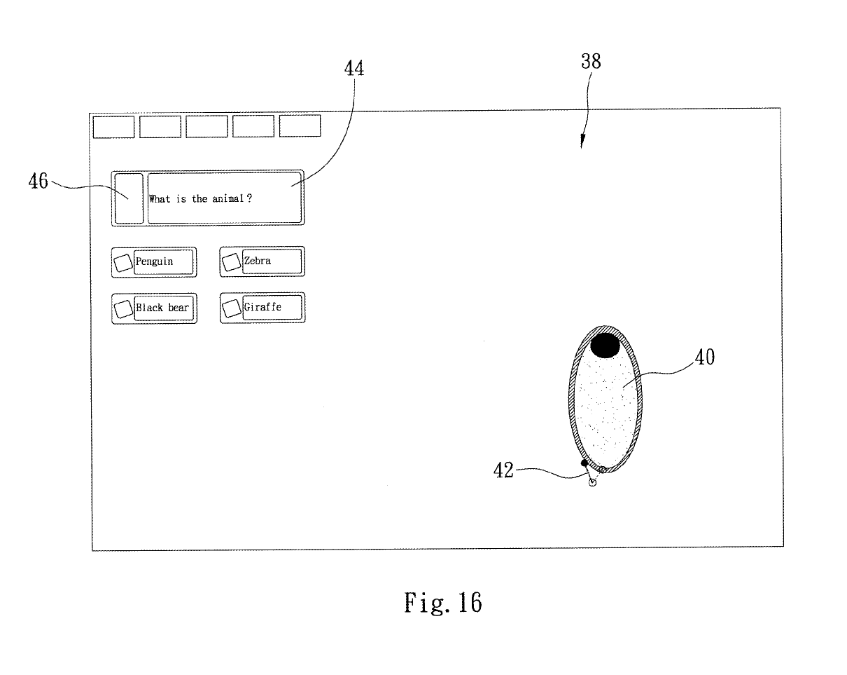

Additionally, drawing interface 38 contains a question window 44 and a scoring window 46 as shown in FIG. 16 for the fourth preferred embodiment. The question window 44 provides questions to ask children, such as “what is the animal?”, and some answers for the children to choose, such as “penguin”, “zebra”, “black bear”, and “giraffe”. The scoring window 46 gives a score according to how fast the user gives the right answer. Actually, it depends on how many sequences of dots have been completed before the right answer is given. The fewer sequences the user needs, the higher score the user can get. The question window 44 and the scoring window 46 of the fourth preferred embodiment can be used in other preferred embodiments of the present invention to have more fun in the game.

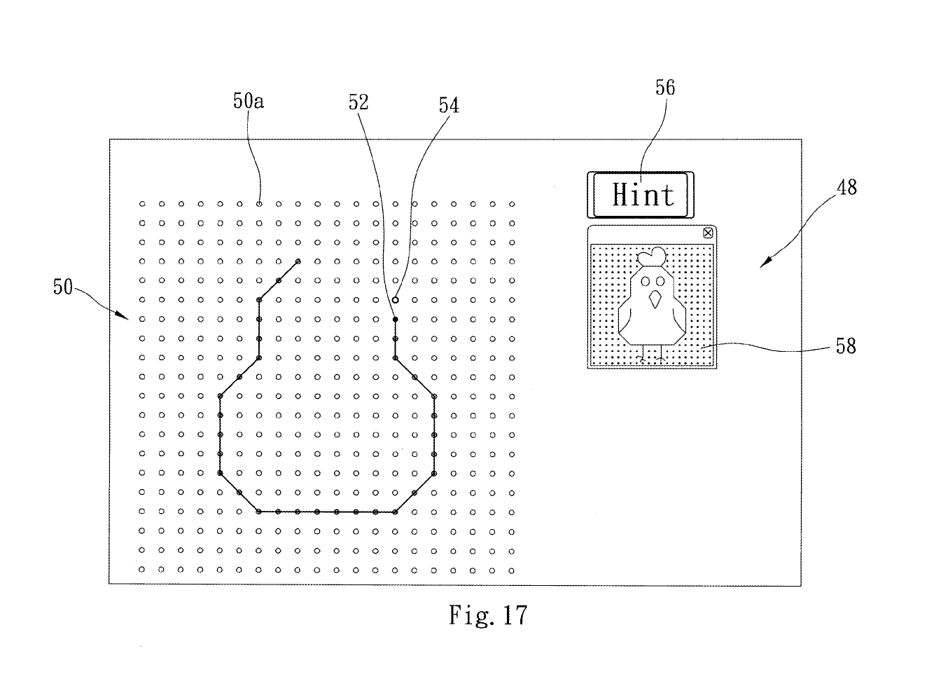

FIG. 17 shows the fifth preferred embodiment of the present invention. A drawing interface 48 appears after clicking or hitting the “cock”. A cock will be drawn. The drawing interface 48 has an array 50 formed by a number of red dots 50a. The dots for the dot-connecting-drawing distribute over the array. A blue dot 52 is used as the starting dot, and its next dot is shown as a hollow dot 54. When the child correctly connects from the blue dot 52 to the hollow dot 54, a connecting line appears between them and the hollow dot becomes a blue dot. In the meantime, there is another red dot 50a converted into a hollow dot. The user is supposed to connect from the new blue dot to the hollow dot next. This process continues until the shape of a cock appears. This kind of dot-connecting-drawing is another way to train children's concentration.

The drawing interface 48 also contains a “hint” button 56. An auxiliary window 58 is opened to show the shape of what the child is going to draw when the “hint” button is clicked or hit. The “hint” function is applicable to all of the embodiments of the present invention mentioned earlier.

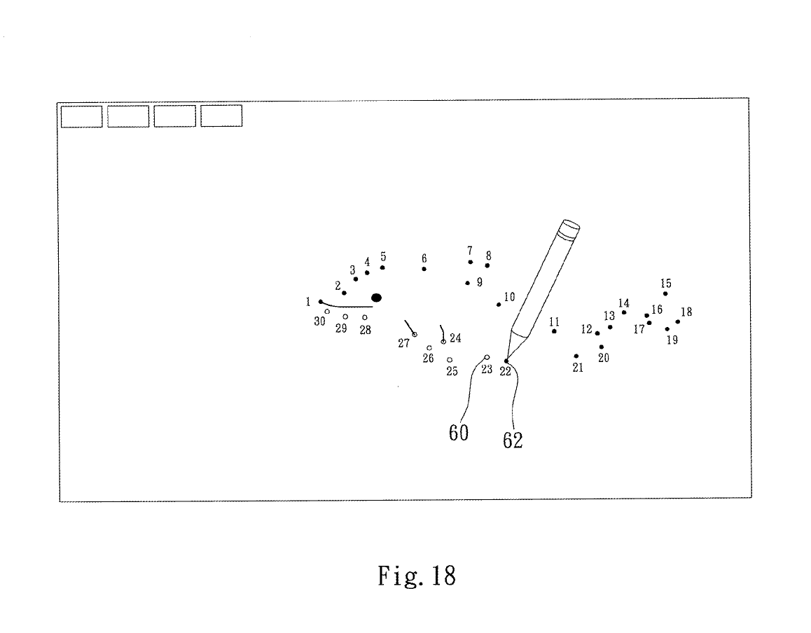

In the previous preferred embodiments, a connecting line appears between two adjacent dots when they are connected successively in the process of dot-connecting-drawing. The sixth preferred embodiment of the present invention shows another way to tell the success of connection between two dots in FIG. 18. In the beginning, all the dots are not connected. The starting dot is represented by one color (first color) and the rest of dots are represented by another color (second color). The dot-connecting-drawing starts from the starting dot. The dot changes its color from the first color to the second color when it is connected. Hence, the dots 62 have been connected are represented by one color (shown as solid dots) and the dots 60 have not been connected are represented by another (shown as hollow dots).

In the above embodiments, the pen 2 is used to draw on the touch screen 1a to connect the dots. However, the execution of dot-connecting-drawing is not limited to be performed by the pen 2 and the touch screen 1a. For example, rather than using a pen, the user can use a mouse to move and control an arrow on the screen. If so, the screen is not limited to a touch screen.

The description above is a few preferred embodiments of the present invention and the equivalence of the present invention is still in the scope of claim construction of the present invention.

What is claimed is:

1. An interactive learning method with drawing, which is implemented by execution of a program incorporated with a screen, comprising the steps of:
(1) clicking a connection item on the screen to activate a drawing interface with dots;
(2) asking a user to connect the dots in a predetermined sequence; and
(3) examining if each of the dots is accurately connected in the sequence, and asking the user to connect again from the previous dot when the dot is not accurately connected.

2. The method as defined in claim 1, further comprising the step of showing a connecting line on the screen between two of the dots when the dots are accurately connected.

3. The method as defined in claim 1, wherein the dots not connected yet are represented by a first color, and are changed to be represented by a second color when the dots are accurately connected.

4. The method as defined in claim 2, wherein a plurality of numbers are provided beside the dots on the screen.

5. The method as defined in claim 3, wherein a plurality of numbers are provided beside the dots on the screen.

6. The method as defined in claim 1, further comprising the step of providing another sequence of dots to wait for connection after the dots are accurately connected.

7. The method as defined in claim 6, further comprising the step of showing at least a portion of a picture related to the connection item or filling in color in a region surrounded by the dots when the dots are accurately connected.

8. The method as defined in claim 6, further comprising the step of providing a question window to ask the user to answer what the user is connecting and a scoring window to show a score according to answers of the user.

9. The method as defined in claim 1, further comprising the step of providing at least a new dot on the screen appended to the end of the sequence for connection when the user has accurately connected one of the dots on the screen.

10. The method as defined in claim 1, wherein the dots are shown in an array on the screen, and the dots for connection are represented by a first color and the rest of the dots in the array are represented by a second color.

11. The method as defined in claim 10, further comprising the step of changing at least one of the dots with the second color to be with the first color and allowing the user to connect the dots from the last dot in the sequence when the user has accurately connected one of the dots of the first color on the screen.

12. The method as defined in claim 1, further comprising the step of playing an animation, a video or pictures after all of the dots are accurately connected.

13. The method as defined in claim 12, further comprising the step of showing a learning image after playing the animation, wherein the learning image has at least one interpretation point for the user to click, and a name of an object associated with the interpretation point is shown and read when the interpretation point is clicked.

14. The method as defined in claim 12, further comprising the step of providing a quiz game about the animation or the pictures after playing the animation or showing the pictures.

15. The method as defined in claim 1, wherein the user uses a mouse to move and control an arrow on the screen to connect the dots.

16. The method as defined in claim 1, wherein the screen used is a touch screen, and the user connects dots by using a pen to draw on a touch screen.

17. The method as defined in claim 1, further comprising the step of providing an auxiliary window after clicking the connection item on the screen to give the user a hint about what the user is going to connect.
